(19) United States
(12) Patent Application Publication
(10) Pub. No.: US 2013/0080036 A1
(43) Pub. Date: Mar. 28, 2013

(54) DEVICE AND METHOD FOR CONTROLLING START OF COMPRESSION SELF-IGNITION ENGINE

(71) Applicants: Takeo Yamauchi, Aki-gun (JP); Yoshihisa Nakamoto, Hiroshima-shi (JP); Junichi Taga, Higashihiroshima-shi (JP)

(72) Inventors: Takeo Yamauchi, Aki-gun (JP); Yoshihisa Nakamoto, Hiroshima-shi (JP); Junichi Taga, Higashihiroshima-shi (JP)

(73) Assignee: Mazda Motor Corporation, Aki-gun (JP)

(21) Appl. No.: 13/594,678

(22) Filed: Aug. 24, 2012

(30) Foreign Application Priority Data
Sep. 26, 2011 (JP) 2011-209446

(51) Int. Cl. F02D 45/00; F02D 41/26

(52) U.S. Cl. 701/112

(57) ABSTRACT

A start control device includes: a compression self-ignition engine; fuel injection valves; a piston stop position detector; a starter motor; a controller for automatically stopping the engine when a predetermined stop condition is satisfied, and thereafter, when a predetermined restart condition is satisfied, restarting the engine by injecting fuel into the compression-stroke-in-stop cylinder; and an intake airflow amount adjuster. In automatically stopping the engine, the controller controls the intake airflow amount adjuster so that the intake airflow amount for a cylinder on an intake stroke between a final top dead center (TDC) of the cylinder immediately before the engine is stopped and an immediate previous TDC of the final TDC increases above an intake airflow amount for another cylinder on the intake stroke between a second previous TDC of the final TDC and the immediate previous TDC of the final TDC.

### BACKGROUND

The present invention relates to a start control device including a compression self-ignition engine for combusting a fuel injected into a cylinder by a self-ignition. The start control device automatically stops the engine when a predetermined automatic stop condition is satisfied, and when a predetermined restart condition is satisfied, restarts the engine by injecting the fuel into a compression-stroke-in-stop cylinder that is on a compression stroke while the engine is stopped, while applying a torque to the engine by using a starter motor.

In recent years, compression self-ignition engines represented by a diesel engine have been widely familiarized as in-vehicle engines for reasons of their generally excellent thermal efficiency and less discharge amount of CO₂ compared to spark-ignition engines, such as gasoline engines.

For larger reduction of CO₂ in such compression self-ignition engines, it is effective to adopt the art of a so called idle stop control of automatically stopping the engine under, for example, an idle drive, and then automatically restarting the engine when, for example, a starting operation of the vehicle is performed, and various studies relating to this have been performed.

For example, JP2009-062960A (paragraph [0048]) discloses a control device of a diesel engine for automatically stopping the diesel engine when a predetermined automatic stop condition is satisfied, and when a predetermined restart condition is satisfied, restarting the diesel engine by injecting a fuel while applying a torque to the engine by driving a starter motor. Further, it is disclosed that a cylinder into which the fuel is injected first is changeably set based on a stop position of a piston of a cylinder that is on a compression stroke while an engine is stopped, in other words, when the engine stop is completed (compression-stroke-in-stop cylinder).

Further specifically, when the diesel engine is automatically stopped, a position of the piston of the compression-stroke-in-stop cylinder that is on the compression stroke at that time is determined, and it is determined whether the piston position is within a predetermined reference stop position range set relatively on a bottom dead center (BDC) side. When the piston position is within the reference stop position range, in restarting the engine, the fuel is injected into the compression-stroke-in-stop cylinder first, and on the other hand, when the piston position is on a top dead center (TDC) side of the reference stop position range, when the engine overall passes the TDC for the first time in the restart and an intake-stroke-in-stop cylinder (cylinder on intake stroke while the engine is stopped) reaches the compression stroke, the fuel is injected into the intake-stroke-in-stop cylinder.

According to such a configuration, when the piston of the compression-stroke-in-stop cylinder is within the reference stop position range, by injecting the fuel into the compression-stroke-in-stop cylinder, the fuel can surely self-ignite and the engine can promptly be restarted in a comparatively short time period (referred to as “the first compression start” for convenience). On the other hand, when the piston of the compression-stroke-in-stop cylinder is on a TDC side of the reference stop position range, because a compression stroke amount (compression margin) is less and a temperature of air inside the cylinder does not rise sufficiently, a misfire may occur even when the fuel is not injected into the compression-stroke-in-stop cylinder. Therefore, in such a case, the fuel is injected into the intake-stroke-in-stop cylinder and not the compression-stroke-in-stop cylinder, and thereby, the air inside the cylinder is sufficiently compressed and the fuel can surely self-ignite (referred to as “the second compression start” for convenience).

Further, regarding the automatic stop control of the engine, JP2009-222002A (paragraph [0047]), for example, discloses a diesel engine for suppressing an opening of an intake valve in an early-half period of the engine automatic stop control so as to suppress an introduction of fresh air into a cylinder, suppress a decrease of a cylinder internal temperature, and suppress a glow power distribution in restarting the engine. Note that in a later-half period of the engine automatic stop control, the intake valve is opened and the fresh air is introduced into the cylinder.

However, with the art disclosed in JP2009-062960A, although the engine can promptly be restarted when the piston of the compression-stroke-in-stop cylinder is within the reference stop position range, when the piston of the compression-stroke-in-stop cylinder is outside the reference stop position, because the fuel is required to be injected into the intake-stroke-in-stop cylinder, the self-ignition based on the fuel injection cannot be performed until the piston of the intake-stroke-in-stop cylinder reaches near a compression TDC (i.e., until the engine overall reaches the second TDC), and thus, there has been a problem that a restart time period (the time period from the start of driving the starter motor to a complete explosion of the engine) becomes long.

Thus, in order to achieve a stable first compression start that contributes to shortening the restart time period, the piston stop position of the compression-stroke-in-stop cylinder is required to be stabilized and stopped relatively on the TDC side. As an art for achieving the shortening, for example, it has been proposed to adjust an absorbed torque (power generation amount) from an alternator such that it is performed in the conventional automatic stop control of a spark-ignition engine, so as to control a speed of the cylinder passing through the TDC during the engine automatic stop control, and as a result, to achieve a desired piston stop position. However, because the compression self-ignition engine generally has a large inertial mass in rotation, it is difficult to finely control the alternator and settle the piston stop position at a desired stop position. Especially, in a vehicle installed with a manual transmission (MT), because a dual mass flywheel (DMF) is equipped therein in many cases, the inertia mass in rotation is larger, and it becomes difficult to settle the piston stop position at the desired stop position through controlling the alternator.

### SUMMARY

The present invention is made in view of the above situations, and stops, when automatically stopping a compression self-ignition engine, a piston of a compression-stroke-in-stop cylinder at a position relatively on the TDC side highly accurately so that when the engine is restarted, the fuel injected into the compression-stroke-in-stop cylinder surely self-ignites and the engine is promptly restarted by a first compression start.

According to one aspect of the invention, a start control device is provided. The device includes: a compression self-ignition engine; fuel injection valves for injecting fuel into cylinders of the engine, respectively; a piston stop position detector for detecting stop positions of pistons; a starter motor for applying a rotational force to the engine, the engine combusting through a self-ignition, the fuel injected into the cylinders by the fuel injection valves; a controller for automatically stopping the engine when a predetermined automatic stop condition is satisfied, and thereafter, when a predetermined restart condition is satisfied and the stop position of the piston of a compression-stroke-in-stop cylinder that is on a compression stroke while the engine is stopped is within a reference stop position range set relatively on a bottom dead center side, restarting the engine by injecting the fuel into the compression-stroke-in-stop cylinder while applying the rotational force to the engine by using the starter motor; and an intake airflow amount adjuster for adjusting a flow amount of intake air into each cylinder. In automatically stopping the engine, the controller controls the intake airflow amount adjuster so that the intake airflow amount for one of the cylinders that is on intake stroke between a final top dead center (hereinafter final TDC) of the cylinder immediately before the engine is stopped and an immediate previous TDC (hereinafter 2TDC) of the final TDC increases above an intake airflow amount for another cylinder on the intake stroke between a second previous TDC (hereinafter 3TDC) of the final TDC and the immediate previous TDC of the final TDC.

According to this configuration, the cylinder that is on the intake stroke between the 2TDC and the final TDC is the compression-stroke-in-stop cylinder that reaches compression stroke after the final TDC, and the other cylinder that is on the intake stroke between the 3TDC and the 2TDC is an expansion-stroke-in-stop cylinder (i.e., the cylinder that is on the expansion stroke while the engine is stopped) in which the stroke precedes that in the compression-stroke-in-stop cylinder by one stroke. Therefore, according to this aspect of the invention, the intake air amount for the compression-stroke-in-stop cylinder increases above the intake air amount for the expansion-stroke-in-stop cylinder immediately before the compression self-ignition engine automatically stops. In this manner, when the engine is stopped, a compressive reaction force (i.e., a reaction force to a positive pressure of the compressed air) inside the compression-stroke-in-stop cylinder becomes relatively large, and an expansion reaction force (i.e., a reaction force to a negative pressure of the expanded air) inside the expansion-stroke-in-stop cylinder relatively reduces. Therefore, the piston of the compression-stroke-in-stop cylinder naturally stops relatively on a bottom dead center side (BDC) and the piston of the expansion-stroke-in-stop cylinder naturally stops relatively on the TDC side. As a result, the piston of the compression-stroke-in-stop cylinder can be stopped relatively on the BDC side with high accuracy, and the compression self-ignition engine can stably and promptly be restarted by the first compression start.

The intake airflow amount adjuster may be an intake throttle valve provided in an intake passage. Until around the immediate previous TDC of the final TDC, the controller may set an opening of the intake throttle valve to have a first intake air amount, and after around the immediate previous TDC of the final TDC, the controller may set the opening to have a second intake airflow amount above the first intake airflow amount.

According to this configuration, by controlling the opening of the intake throttle valve, the intake air amount for the compression-stroke-in-stop cylinder can stably and surely be increased to be larger than the intake air amount for the expansion-stroke-in-stop cylinder, and the piston of the compression-stroke-in-stop cylinder can be stopped relatively on the BDC side with high accuracy. Further, because the intake throttle valve is a conventional member generally provided to engines, the configuration of the start control device is not complex. Further, because the intake airflow amount is relatively small in the major part of the period of the engine automatic stop control until around the 2TDC, the compressive reaction force becomes relatively small and leads to good noise, vibration and harshness (NVH) during the engine automatic stop control. Further, because the introduction of fresh air is relatively less in the major part of the period of the engine automatic stop control until around the 2TDC, the cylinder is suppressed from being cooled internally and fuel self-ignitability during the restart is secured.

Note the phrase “around the 2TDC” indicates a range between a time point before the 2TDC by a predetermined time period and a time point after the 2TDC by a predetermined time period. The reason for defining “around the 2TDC” as such is that the intake air amount for the compression-stroke-in-stop cylinder can be increased above the intake air amount for the expansion-stroke-in-stop cylinder not only when changing the opening of the intake throttle valve at the 2TDC, but also when changing the opening of the intake throttle valve at the time point before or after the 2TDC by the predetermined time period.

The intake airflow amount adjuster may be a variable valve mechanism for changing at least one of a lift and opening and closing timings of an intake valve. Until around the immediate previous TDC of the final TDC, the controller may set at least one of the lift and the opening and closing timings of the intake valve to have a first intake air amount, and after around the immediate previous TDC of the final TDC, the controller may set at least one of the lift and the opening and closing timings to have a second intake airflow amount above the first intake airflow amount.

According to this configuration, by controlling at least one of the lift and the opening and closing timings of the intake valve via the variable valve mechanism, the intake air amount for the compression-stroke-in-stop cylinder can stably and surely be increased above the intake air amount for the expansion-stroke-in-stop cylinder, and the piston of the compression-stroke-in-stop cylinder can be stopped relatively on the BDC side with high accuracy. Further, because the variable valve mechanism is a conventional member generally provided to engines, the configuration of the start control device is not complex. Further, because the intake airflow amount is relatively small in the major part of the period of the engine automatic stop control until around the 2TDC, the compressive reaction force becomes relatively small and leads to good NVH during the engine automatic stop control. Further, because the introduction of fresh air is relatively less in the major part of the period of the engine automatic stop control until around the 2TDC, the cylinder is suppressed from being cooled internally and a fuel self-ignitability during the restart is secured.

Note the phrase “around the 2TDC” indicates a range between a time point before the 2TDC by a predetermined time period and a time point after the 2TDC by a predetermined time period. The reason of defining as such is that the intake air amount for the compression-stroke-in-stop cylinder can be increased above the intake air amount for the expansion-stroke-in-stop cylinder not only when changing at least one of the lift and the opening and closing timings of the intake valve at the 2TDC but also when changing at least one of the lift and the opening and closing timings of the intake valve at the time point before or after the 2TDC by the predetermined time period.

Until around the immediate previous TDC of the final TDC, the controller may close the intake valve before a bottom dead center, and after around the immediate previous TDC of the final TDC, the controller may close the intake valve after the bottom dead center.

According to this configuration, by changing the closing timing of the intake valve (i.e., IVC timing), the intake air amount for the compression-stroke-in-stop cylinder can easily and surely be increased to be larger than the intake air amount for the expansion-stroke-in-stop cylinder, and the piston of the compression-stroke-in-stop cylinder can be stopped relatively on the BDC side with high accuracy.

As described above, according to the invention, in automatically stopping the compression self-ignition engine, the piston of the compression-stroke-in-stop cylinder can be stopped relatively on the BDC side with high accuracy. As a result, in restarting the engine, the fuel injected into the compression-stroke-in-stop cylinder can surely self-ignite and the engine can be restarted promptly by the first compression start. Therefore, uncertainty and inconvenience associated with lengthy restarts of the engine is reduced.

### BRIEF DESCRIPTION OF THE DRAWINGS

FIG. 1 is a systematic configuration diagram showing an overall configuration of a diesel engine applied with a start control device according to an embodiment of the invention.

FIG. 2 is a time chart showing changes of state quantities in an engine automatic stop control.

FIG. 3 shows a state of inside cylinders immediately before the engine automatic stop and positions of pistons of the cylinders immediately after the engine automatic stop, to illustrate an operation of the automatic stop control.

FIG. 4 is a chart showing a relation between an engine speed when the piston passes a final top dead center (TDC) and a piston stop position of a compression-stroke-in-stop cylinder.

FIG. 5 is a flowchart showing an example of a specific operation of the engine automatic stop control.

FIG. 6 is a flowchart showing an example of a specific operation of an engine restart control.

### DETAILED DESCRIPTION OF THE EMBODIMENTS

### (1) Overall Configuration of Engine

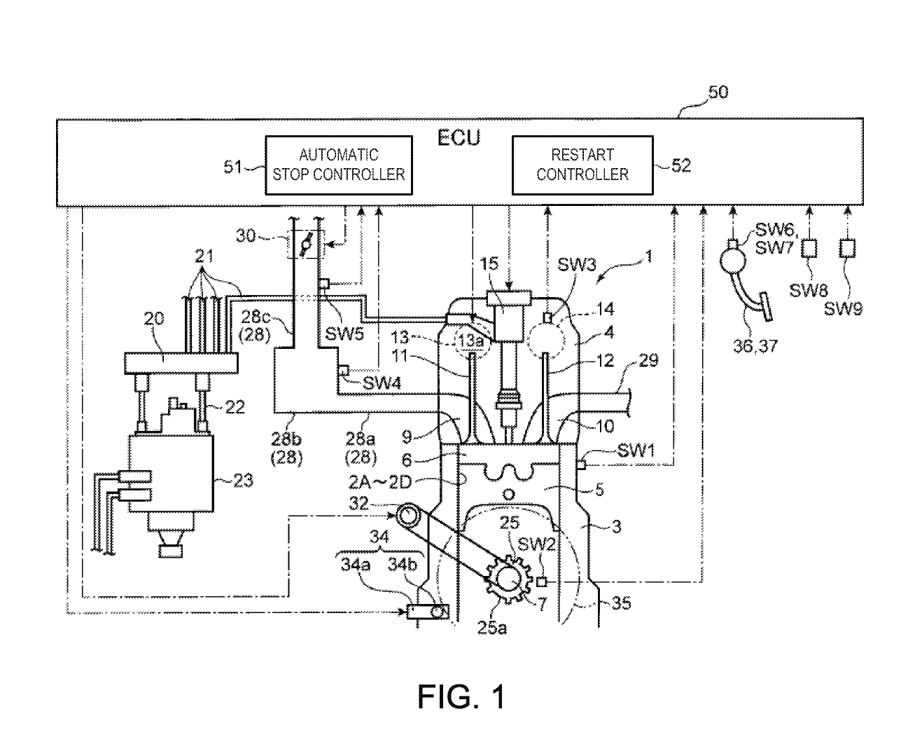

FIG. 1 is a system configuration diagram showing an overall configuration of a diesel engine applied with a start control device according to an embodiment of the invention. The diesel engine shown in FIG. 1 is a four cycle diesel engine mounted in a vehicle as a power source for driving the vehicle. An engine body 1 of the engine is an inline four cylinder type and includes a cylinder block 3 having four cylinders 2A to 2D aligning in a direction where the cylinders overlap with each other in FIG. 1, a cylinder head 4 disposed on the top of the cylinder block 3, and pistons 5 reciprocatably fitted into the cylinders 2A to 2D respectively.

A combustion chamber 6 is formed above each piston 5, and each combustion chamber 6 is supplied with fuel (e.g., diesel fuel) injected from a fuel injection valve 15, described later. Further, the injected fuel self-ignites in the combustion chamber 6 where temperature and pressure are high because of a compression operation by the piston 5 (i.e., a self-igniting compression), and the piston 5 is pushed down by an expansive force due to the combustion caused by the ignition and reciprocatably moves in a vertical direction.

Each piston 5 is coupled to a crankshaft 7 via a connecting rod (arranged outside the range of FIG. 1), and the crankshaft 7 rotates about its central axis according to the reciprocation movement (i.e., vertical movement) of the pistons 5.

Here, in the four-cycle four-cylinder diesel engine, the pistons 5 provided in the cylinders 2A to 2D vertically move with a phase difference of 180° in crank angle (180° CA). Therefore, combustion timing (i.e., fuel injection) in the cylinders 2A to 2D are set to vary in phase by 180° CA from each other. Specifically, when the cylinders 2A to 2D are numbered 1 to 4 in firing order, respectively, the combustion is performed in the order of the first cylinder 2A, the third cylinder 2C, the fourth cylinder 2D, and then the second cylinder 2B. Therefore, for example, when the first cylinder 2A is on an expansion (EXP) stroke, the third cylinder 2C, the fourth cylinder 2D, and the second cylinder 2B are on a compression (CMP) stroke, intake (IN) stroke, and exhaust (EX) stroke, respectively.

The cylinder head 4 is provided with intake and exhaust ports 9 and 10 opening into the combustion chambers 6 of the cylinders 2A to 2D, and intake and exhaust valves 11 and 12 for opening and closing the ports 9 and 10, respectively. Note that, the intake and exhaust valves 11 and 12 are opened and closed by valve operating mechanisms 13 and 14 that respectively include a pair of camshafts arranged in the cylinder head 4, in conjunction with the rotation of the crankshaft 7. The valve operating mechanism 13 of the intake valves 11 is provided with a variable valve mechanism 13a for changing at least one of a lift of the intake valve 11 and opening and closing timings thereof. In view of adjusting an intake airflow amount into the cylinder, the variable valve mechanism 13a corresponds to the intake airflow amount adjuster in the claims.

Further, the cylinder head 4 is provided with one fuel injection valve 15 for each cylinder, and each fuel injection valve 15 is connected therewith via a common rail 20 serving as an accumulating chamber, and a branched tube 21. The common rail 20 is supplied with fuel (e.g., diesel fuel) from a fuel supply pump 23 via a fuel supply tube 22 at high pressure, and the highly-pressurized fuel inside the common rail 20 is supplied to each fuel injection valve 15 via the branched tube 21.

Each fuel injection valve 15 comprises an electromagnetic needle valve provided in its tip with an injection nozzle formed with a plurality of holes, a fuel passage leading to the injection nozzle, and a needle valve body, electromagnetically operated for opening and closing the fuel passage, provided inside the fuel injection valve 15 (both not illustrated). Further, by driving the valve body in an opening direction by using the electromagnetic force obtained through a power distribution, the fuel supplied from the common rail 20 is directly injected from each hole of the injection nozzle into the combustion chamber 6.

The cylinder block 3 and the cylinder head 4 are formed therein with a water jacket (arranged outside the range of FIG. 1) where a coolant flows, and a water temperature sensor SW1 for detecting a temperature of the coolant inside the water jacket is formed in the cylinder block 3.

Further, a crank angle sensor SW2 for detecting a rotational angle and a rotational speed of the crankshaft 7 is provided in the cylinder block 3. The crank angle sensor SW2 outputs a pulse signal corresponding to the rotation of a crank plate 25 that rotates integrally with the crankshaft 7.

Specifically, multiple teeth aligned via a fixed pitch are convexly arranged in an outer circumferential part of the crank plate 25, and a tooth-lacking part 25a (i.e., the part with no tooth) for identifying a reference position is formed in a predetermined area of the outer circumferential part. Further, the crank plate 25 having the tooth-lacking part 25a at the reference position rotates and the pulse signal based thereon is outputted from the crank angle sensor SW2, and thus, the rotational angle (i.e., crank angle) and the rotational speed of the crankshaft 7 (i.e., engine speed) are detected.

On the other hand, the cylinder head 4 is provided with a cam angle sensor SW3 for detecting an angle of the camshaft for valve operation (not illustrated). The cam angle sensor SW3 outputs a pulse signal for cylinder determination corresponding to the transit of teeth of a signal plate for rotating integrally with the camshaft.

In other words, the pulse signal outputted from the crank angle sensor SW2 includes a no-signal portion generated every 360° CA corresponding to the tooth-lacking part 25a. Using only the information obtained from the no-signal portion, for example, while the piston 5 rises, the corresponding cylinder and the corresponding stroke between the compression stroke and exhaust stroke cannot be determined. Therefore, the pulse signal is outputted from the cam angle sensor SW3 based on the rotation of the camshaft that rotates once every 720° CA, and based on a timing of the signal output and a timing of the no-signal portion output from the crank angle sensor SW2 (i.e., transit timing of the tooth-lacking part 25a), the cylinder determination is performed.

The intake and exhaust ports 9 and 10 are connected with intake and exhaust passages 28 and 29, respectively. Thus, intake air (i.e., fresh air) from outside is supplied to the combustion chamber 6 via the intake passage 28 and exhaust gas (i.e., combusted gas) generated in the combustion chamber 6 is discharged outside via the exhaust passage 29.

In the intake passage 28, an area of a predetermined length upstream from the engine body 1 is defined as a branched passage 28a respectively branched for each of the cylinders 2A to 2D, and upstream ends of the branched passage 28a are connected with a surge tank 28b. A single common passage 28c is formed upstream of the surge tank 28b.

The common passage 28c is provided with an intake throttle valve 30 for adjusting an air amount (i.e., an intake air amount) to flow into the cylinders 2A to 2D. The intake throttle valve 30 is basically kept fully opened or largely opened while the engine is in operation, and is closed to isolate the intake passage 28 as needed to stop the engine, for example. In view of adjusting an intake airflow amount into the cylinder, the intake throttle valve 30 corresponds to the intake airflow amount adjuster in the claims.

An intake pressure sensor SW4 for detecting an intake pressure is provided to the surge tank 28b and an airflow sensor SW5 for detecting an intake airflow rate is provided to the common passage 28c between the surge tank 28b and the intake throttle valve 30.

The crankshaft 7 is coupled to an alternator 32 via, for example, a timing belt. The alternator 32 is built therein with a regulator circuit for controlling a current of a feed coil (arranged outside the range of FIG. 1) to adjust a power generation amount, and obtaining a driving force from the crankshaft 7 to generate a power based on a target value of the power generation amount (i.e., a target power generating current) determined based on, for example, an electrical load of the vehicle and a remaining level of a battery.

The cylinder block 3 is provided with a starter motor 34 for starting the engine. The starter motor 34 includes a motor body 34a and a pinion gear 34b rotatably driven by the motor body 34a. The pinion gear 34b is detachably matched with a ring gear 35 coupled to an end of the crankshaft 7. When starting the engine by the starter motor 34, the pinion gear 34b moves to a predetermined matching position to match with the ring gear 35 and a rotational force of the pinion gear 34b is transmitted to the ring gear 35, and thereby, the crankshaft 7 is rotationally driven.

### (2) Control System

Each component of the engine configured as above is controlled overall by an electronic control unit (ECU) 50. The ECU 50 is a microprocessor comprising, for example, a CPC, a ROM, and a RAM that are well known, and corresponds to a controller in the claims.

The ECU 50 is inputted with various information from the various sensors. In other words, the ECU 50 is connected with the water temperature sensor SW1, the crank angle sensor SW2, the cam angle sensor SW3, the intake pressure sensor SW4, and the airflow sensor SW5 that are provided as parts of the engine, respectively. The ECU 50 acquires the various information including the temperature of the coolant of the engine, the crank angle, the engine speed, the cylinder determination result, the intake pressure, and the intake airflow rate, based on the input signals from the sensors SW1 to SW5.

Further, the ECU 50 is also inputted with information from various sensors (SW6 to SW9) provided to the vehicle. In other words, the vehicle is provided with an accelerator position sensor SW6 for detecting a position of an acceleration pedal 36 pressed by a driver, a brake sensor SW7 for detecting whether a brake pedal 37 is ON/OFF (i.e., the application of the brake), a vehicle speed sensor SW8 for detecting a traveling speed of the vehicle (i.e., vehicle speed), and a battery sensor SW9 for detecting the remaining level of the battery (not illustrated). The ECU 50 acquires the information including the accelerator position, the application of the brake, the vehicle speed, and the remaining level of the battery, based on the input signals from the sensors SW6 to SW9.

The ECU 50 controls the components of the engine respectively while performing various calculations based on the inputted signals from the sensors SW1 to SW9. Specifically, the ECU 50 is electrically connected with the fuel injection valve 15, the intake throttle valve 30, the alternator 32, the starter motor 34, and the variable valve mechanism 13a provided to the valve operating mechanism 13 of the intake valve 11, and outputs drive control signals to these components, respectively, based on the results of the calculations.

Next, the function of the ECU 50 is described in further detail. In normal operation of the engine, the ECU 50 has basic functions such as: injecting a required amount of fuel based on operating conditions from the fuel injection valve 15; and generating a required amount of power based on, for example, the electrical load on the vehicle and the remaining level of the battery by the alternator 32. The ECU 50 also has functions to automatically stop the engine and restart the engine under predetermined conditions, respectively. Therefore, the ECU 50 has an automatic stop controller 51 and a restart controller 52 to serve as functional elements regarding the automatic stop and restart controls of the engine.

During the operation of the engine, the automatic stop controller 51 determines whether the predetermined automatic stop conditions of the engine are satisfied, and when they are satisfied, the automatic stop controller 51 automatically stops the engine.

For example, when a plurality of conditions, such as the vehicle is stopped, are all met and it is confirmed that it would not be disadvantageous to stop the engine, it is determined that the automatic stop conditions are satisfied. Thus, the engine is stopped by stopping the fuel injection from the fuel injection valve 15 (i.e., a fuel cut).

After the engine is automatically stopped, the restart controller 52 determines whether the restart condition is satisfied, and when it is satisfied, the restart controller 52 restarts the engine.

For example, when the engine is required to be started, such as when the driver presses the acceleration pedal 36, the restart condition is determined to be satisfied. Thus, by restarting the fuel injection from the fuel injection valve 15 while applying the rotational force on the crankshaft 7 by driving the starter motor 34, the restart controller 52 restarts the engine.

### (3) Automatic Stop Control

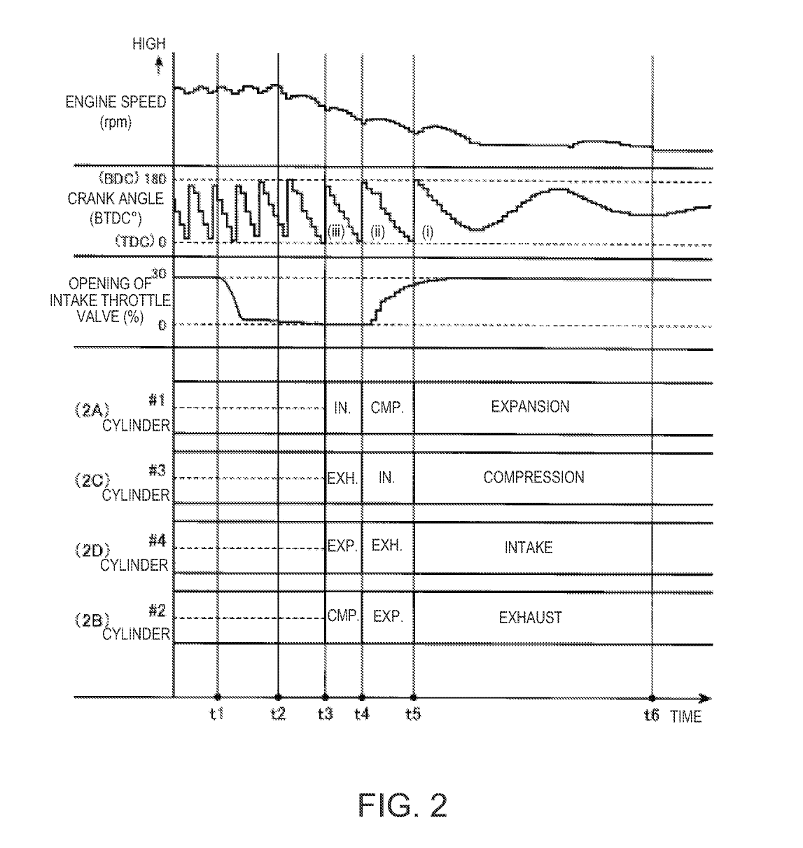

Next, the contents of the engine automatic stop control performed by the automatic stop controller 51 of the ECU 50 are described further specifically. FIG. 2 is a time chart showing changes of state amounts in the engine automatic stop control. In FIG. 2, a time point at which the engine automatic stop conditions are satisfied is indicated as t1.

As shown in FIG. 2, in the engine automatic stop is executed first by fully closing the opening of the intake throttle valve 30 (i.e., to 0%) at the time point t1, at which the engine automatic stop conditions are satisfied. Then at a time point t2, the step of stopping the fuel injection from the fuel injection valve 15 (i.e., a fuel cut) is performed while the opening of the intake throttle valve 30 is fully closed.

Next, after the fuel cut, while the engine speed gradually decreases, at a time point t4, at which the engine speed when any of the pistons 5 of the four cylinders 2A to 2D passes the top dead center (TDC) (e.g., the engine TDC speed) decelerates to reach a predetermined range, the opening of the intake throttle valve 30 is set to 30%. Note that, the engine speed at the time point t4 is extremely low, therefore, 30% of the opening of the intake throttle valve 30 corresponds to the intake throttle valve 30 being substantially fully opened (i.e., by opening the intake throttle valve 30 to 30%, the same level of fresh air amount as in the fully opened state flows into the cylinder). Further, the predetermined range is experimentally obtained in advance as a range of the engine speed when one of the cylinders 2A to 2D that passes the TDC last (i.e. the final TDC) immediately before the engine is stopped passes an immediate previous TDC (2TDC) of the final TDC. In other words, the time point t4 indicates a time point of reaching the immediate previous TDC (2TDC) (i.e., (ii) in FIG. 2) of the final TDC. Note that, a time point t3 which is earlier than the time point t4 indicates a time point of reaching a second previous TDC (3TDC) (i.e., (iii) in FIG. 2) of the final TDC.

Then, after the final TDC (i.e., (i) in FIG. 2) at the time point t5, although the engine reverses by the backlash of the piston, the engine completely stops at a time point t6 without passing the TDC again.

Such a control is performed to settle the piston stop position of the cylinder that is on the compression stroke when the engine completely stops (compression-stroke-in-stop cylinder, i.e., the third cylinder 2C in FIG. 2) within the reference stop position range highly accurately. The reference stop position range is predetermined to be, for example, between 83° CA and 180° CA before a compression TDC, which is relatively on a bottom dead center (BDC) side. By stopping the piston 5 of the compression-stroke-in-stop cylinder 2C at such a position relatively on the BDC side, when restarting the engine, through injecting the fuel into compression-stroke-in-stop cylinder 2C the first time in the restart (i.e., first time in all the cylinders, the first compression start), the engine can promptly and surely be restarted. In other words, if the piston stop position of the compression-stroke-in-stop cylinder 2C is within the reference stop position range, because a comparatively large amount of air exists in the cylinder 2C, due to the rise of the piston 5 when restarting the engine, a compression stroke amount (i.e., a compression margin) by the piston 5 increases and the air inside the cylinder 2C is sufficiently compressed and increases its temperature. Therefore, when the fuel is injected into the cylinder 2C the first time in the restart, the fuel surely self-ignites inside the cylinder 2C and combusts.

On the other hand, if the piston 5 of the compression-stroke-in-stop cylinder 2C is on the TDC side of the reference stop position range, because the compression stroke amount by the piston 5 becomes less and the temperature of the air inside the compression-stroke-in-stop cylinder 2C does not increase sufficiently, a misfire may occur even if the fuel is injected into the compression-stroke-in-stop cylinder 2C. Thus, in such a case, by injecting the fuel into the intake-stroke-in-stop cylinder (i.e., the cylinder which is on the intake stroke when the engine is completely stopped, for example, the fourth cylinder 2D in FIG. 2) and not the compression-stroke-in-stop cylinder 2C, the air inside the cylinder 2D is sufficiently compressed and the fuel surely self-ignites (i.e., the second compression start).

As above, when the piston 5 of the compression-stroke-in-stop cylinder 2C is within the reference stop position range, the engine can be restarted promptly by the first compression start. On the other hand, when the piston 5 is on the TDC side of the reference stop position range, the fuel is required to be injected into the intake-stroke-in-stop cylinder 2D by the second compression start. Therefore, until the piston 5 of the intake-stroke-in-stop cylinder 2D reaches near the compression TDC (i.e., until the engine overall reaches the TDC the second time in the restart), the self-ignition based on the fuel injection cannot be performed, and a restarting time period (i.e., in this embodiment, the time period from the start of the starter motor 34 until the engine speed reaches 750 rpm) becomes long.

In this regard, the opening of the intake throttle valve 30 is set to 0% until the 2TDC (ii) (i.e., until the time point t4), and after the 2TDC (ii) (i.e., after the time point t4), the opening of the intake throttle valve 30 is set to 30%. In this manner, the intake airflow amount (i.e., the second intake air amount) for the compression-stroke-in-stop cylinder 2C that is on the intake stroke between the 2TDC (ii) and the final TDC (i) (i.e., between the time points t4 and t5) increases above the intake airflow amount (i.e., the first intake air amount) for an expansion-stroke-in-stop cylinder (i.e., a cylinder that is on the expansion stroke when the engine is completely stopped, for example, the first cylinder 2A in FIG. 2) that is on the intake stroke between the 3TDC (iii) and the 2TDC (ii) (i.e., between the time points t3 and t4).

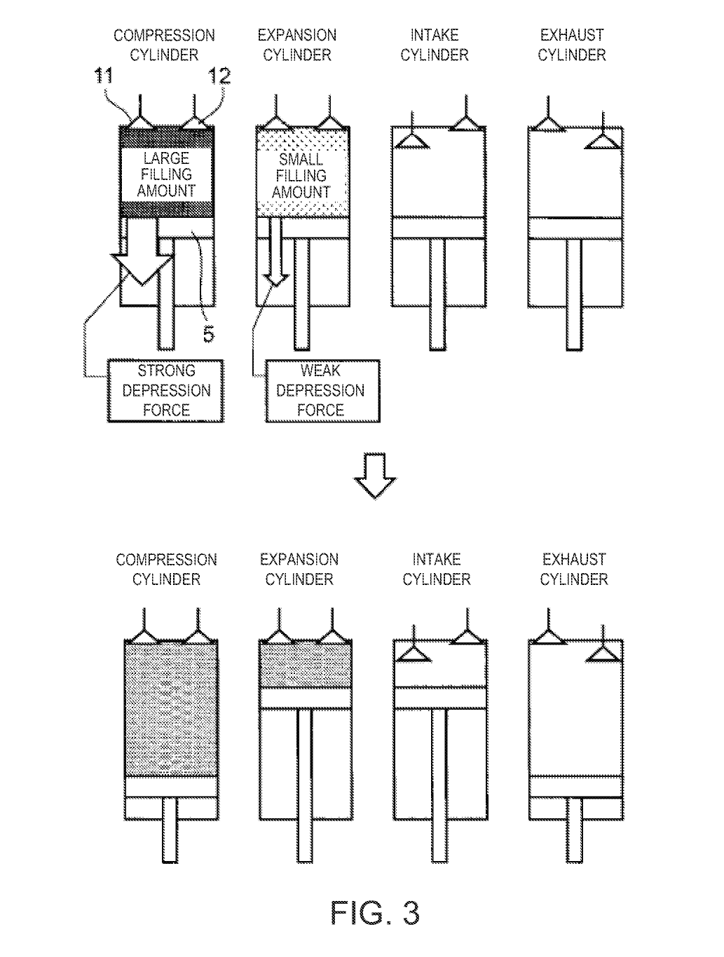

In other words, as shown in FIG. 3, immediately before the engine is automatically stopped, the intake air amount for the compression-stroke-in-stop cylinder 2C increases above the intake air amount for the expansion-stroke-in-stop cylinder 2A. Therefore, as shown in the lower chart in FIG. 3, when the engine is stopped, a compressive reaction force (i.e., a reaction force to a positive pressure of the compressed air) inside the compression-stroke-in-stop cylinder 2C becomes relatively large, and an expansion reaction force (i.e., a reaction force to a negative pressure of the expanded air) inside the expansion-stroke-in-stop cylinder 2A becomes relatively small. Therefore, the piston 5 of the compression-stroke-in-stop cylinder 2C naturally stops relatively on the BDC side and the piston 5 of the expansion-stroke-in-stop cylinder 2A naturally stops relatively on the TDC side. As a result, the piston 5 of the compression-stroke-in-stop cylinder 2C can be stopped relatively on the BDC side with high accuracy, and the compression self-ignition engine can stably and promptly be restarted by the first compression start.

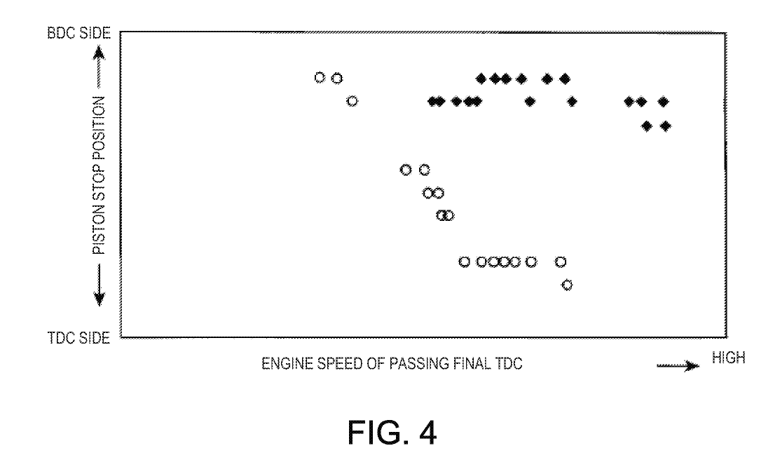

FIG. 4 is a chart showing, in the engine automatic stop control, the change of a relation between the engine speed when the piston reaches the final TDC (i) (i.e., time point t5) and the piston stop position of the compression-stroke-in-stop cylinder 2C in cases where the intake throttle valve 30 is opened to 30% at the time point t4 (♦ symbol) and the intake throttle valve 30 is closed to 0% even after the time point t4 (◯ symbol).

As shown clearly from FIG. 4, if the intake throttle valve 30 is opened to 30% at the time point t4 of reaching the 2TDC (ii) (♦ symbol), regardless of the engine speed of passing the final TDC, the piston 5 of the compression-stroke-in-stop cylinder 2C stably stops on the BDC side. Therefore, the piston stop position of the compression-stroke-in-stop cylinder 2C stably settles within the reference stop position range (i.e., between 83° CA and 180° CA before the compression TDC), and the first compression start provides prompt starting performance with a high rate of success.

On the other hand, if the intake throttle valve 30 is closed to 0% even after the time point t4 of reaching the 2TDC (ii) (◯ symbol), the piston stop position of the compression-stroke-in-stop cylinder 2C depends greatly on the engine speed of passing the final TDC, and the piston 5 of the compression-stroke-in-stop cylinder 2C also stops on the TDC side at high frequency. Therefore, the possibility that the piston stop position of the compression-stroke-in-stop cylinder 2C settles on the TDC side of the reference stop position range becomes high, and the second compression start is inferior to the first compression start in that the second compression start does not provide prompt starting performance with a high rate of success.

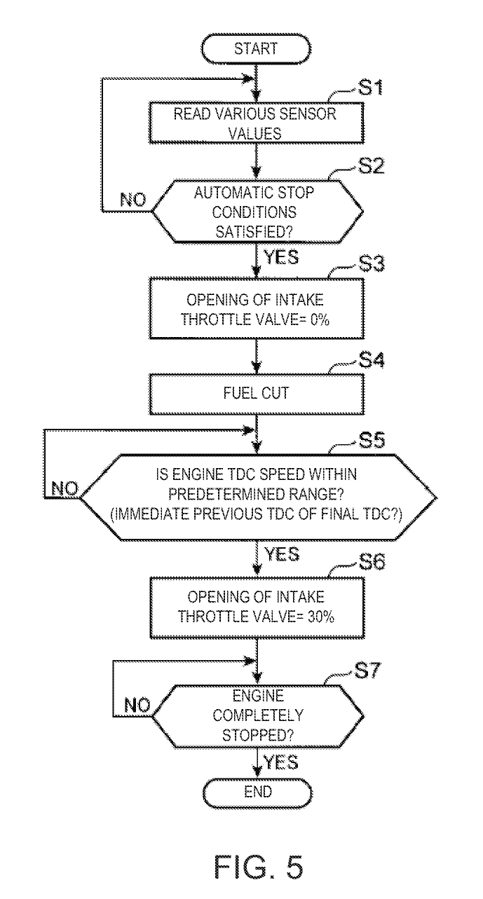

Next, an example of specific control operation of the automatic stop controller 51 of the ECU 50 controlling the engine automatic stop as described above is described with reference to the flowchart in FIG. 5. When the processing shown in the flowchart in FIG. 5 starts, the automatic stop controller 51 reads various sensor values (Step S1). Specifically, the automatic stop controller 51 reads the detection signals from the water temperature sensor SW1, the crank angle sensor SW2, the cam angle sensor SW3, the intake pressure sensor SW4, the airflow sensor SW5, the accelerator position sensor SW6, the brake sensor SW7, the vehicle speed sensor SW8, and the battery sensor SW9, and based on these signals, it acquires various information, such as the coolant temperature of the engine, the crank angle, the engine speed, the cylinder determination result, the intake air pressure, the intake airflow rate, the accelerator position, the brake position, the vehicle speed, and the remaining level of the battery.

Next, based on the information acquired at Step S1, the automatic stop controller 51 determines whether the automatic stop conditions of the engine are satisfied (Step S2). For example, the automatic stop conditions of the engine are determined to be satisfied when a plurality of conditions, such as the vehicle is stopped (i.e., vehicle speed=0 km/h), the position of the acceleration pedal 36 is zero (i.e., accelerator OFF), the brake pedal 37 is in operation (i.e., brake ON), the coolant temperature of the engine is above the predetermined value (i.e., warmed-up state), and the remaining level of the battery is above a predetermined value, are all satisfied. Note that, regarding the vehicle speed, the vehicle is not necessarily completely stopped (i.e., vehicle speed=0 km/h), and it may be below a low vehicle speed (e.g., below 3 km/h).

When it is confirmed that the automatic stop conditions are satisfied (Step S2: YES), the automatic stop controller 51 sets the opening of the intake throttle valve 30 to be fully closed (i.e., 0%) (Step S3). In other words, as shown in the time chart in FIG. 2, at the time point t1 at which the automatic stop conditions are satisfied, the opening of the intake throttle valve 30 is reduced from a predetermined opening (i.e., 30% in the illustration), which is set in the idle drive, to fully closed (i.e., 0%).

Subsequently, the automatic stop controller 51 keeps the fuel injection valve 15 closed to stop the fuel supply from the fuel injection valve 15 (Step S4). In the time chart in FIG. 2, at the time point t2, the fuel supply is stopped (i.e., fuel cut).

Next, the automatic stop controller 51 determines whether the engine speed when the piston 5 of any one of the four cylinders 2A to 2D reaches the TDC (i.e., engine TDC speed) is within a predetermined speed range (Step S5). Note that, as shown in FIG. 2, the engine speed gradually drops while repeating temporal deceleration every time one of the four cylinders 2A to 2D reaches the compression TDC and temporal acceleration after every compression TDC. Therefore, the engine TDC speed can be measured as the engine speed at a timing at which the engine speed starts to accelerate after the deceleration.

The determination relating to the engine TDC speed at Step S5 is performed to specify the timing (i.e., the time point t4 in FIG. 2) of passing the 2TDC. In other words, in the engine automatic stop, because the deceleration of the engine speed has a certain flow, by checking the engine TDC speed when passing the TDC, the preceding number of the checked TDC to the final TDC can be estimated. Thus, by measuring the engine TDC speed constantly and determining whether the measured engine TDC speed is within a range obtained as a predetermined range (i.e., the range of the engine speed when the piston passes the 2TDC) in advance through, for example, an experiment, the timing of passing the 2TDC is specified.

When the current time point is confirmed to be the timing of passing the 2TDC (Step S5: YES), the automatic stop controller 51 opens the intake throttle valve 30 to 30% (Step S6). In this manner, the intake airflow amount (i.e., the second intake air amount) for the compression-stroke-in-stop cylinder 2C that is on the intake stroke between the 2TDC and the final TDC (i.e., between the time points t4 and t5) increases above the intake airflow amount (i.e., the first intake air amount) for the expansion-stroke-in-stop cylinder 2A that is on the intake stroke between the 3TDC and 2TDC.

Further, the automatic stop controller 51 determines whether the engine speed is 0 rpm to determine whether the engine is completely stopped (Step S7). If the engine is completely stopped, the automatic stop controller 51 sets the opening of the intake throttle valve 30 to a predetermined opening (e.g., 80%) which is set in the normal operation. Then, the automatic stop control finishes. After the engine is stopped, because the compressive reaction force of the compression-stroke-in-stop cylinder 2C is above the expansion reaction force of the expansion-stroke-in-stop cylinder 2A, the piston 5 of the compression-stroke-in-stop cylinder 2C naturally stops relatively on the BDC side and settles within the reference stop position range (e.g., between 83° CA and 180° CA before the compression TDC) with high accuracy.

### (4) Restart Control

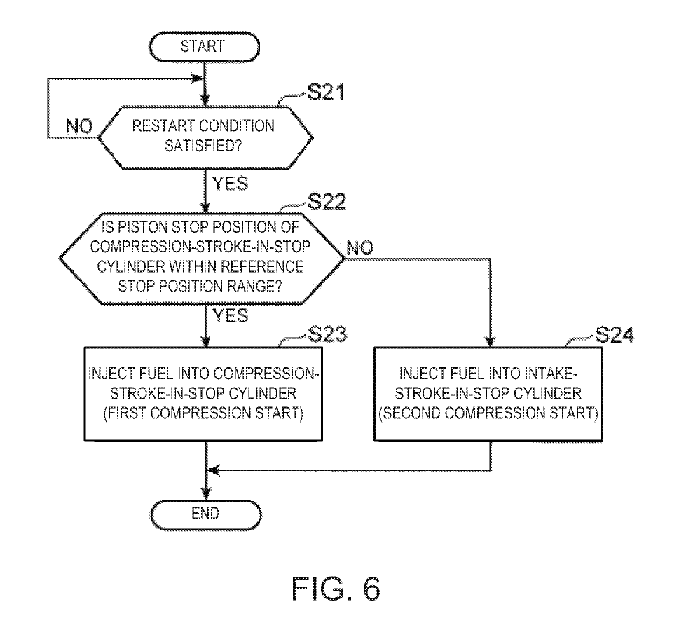

Next, an example of specific control operation of the restart controller 52 of the ECU 50 controlling the engine restart is described with reference to the flowchart in FIG. 6.

When the processing shown in the flowchart in FIG. 6 starts, the restart controller 52 determines whether the restart condition of the engine is satisfied based on the various sensor values (Step S21). For example, the restart condition of the engine is determined to be satisfied when at least one of the following conditions is satisfied: the acceleration pedal 36 is pressed to start the vehicle (i.e., accelerator ON); the remaining level of the battery is decreased; the coolant temperature of the engine is below a predetermined value (i.e., cold start); and the continuous stopped time period of the engine (i.e., the lapsed time period after the automatic stop) exceeds a predetermined time length. Here, the engine restart condition is broadly based on a start requirement from the driver (e.g., starting operation of the vehicle, such as disengaging the clutch and releasing the brake) and others (e.g., systematic reasons such as a necessity of activating an air conditioner, a decrease in battery voltage, and a long automatic stop time period of the engine).

When it is confirmed that the restart condition is satisfied (Step S21: YES), the restart controller 52 determines whether the piston stop position of the compression-stroke-in-stop cylinder 2C is within the reference stop position range (e.g., between 83° CA and 180° CA before the compression TDC) (Step S22).

Here, the piston stop position of the compression-stroke-in-stop cylinder 2C should generally be in the reference stop position range due to the operation of the automatic stop control. However, the piston stop position of the compression-stroke-in-stop cylinder 2C may be outside the reference position range for a number of reasons; therefore, the determination at Step S22 is performed for confirmation.

When the piston stop position of the compression-stroke-in-stop cylinder 2C is confirmed to be within the reference stop position range (Step S22: YES), the restart controller 52 restarts the engine by injecting the fuel into the compression-stroke-in-stop cylinder 2C (i.e., the first compression start) (Step S23). In other words, by injecting the fuel into the compression-stroke-in-stop cylinder 2C for self-ignition while driving the starter motor 34 to apply the rotational force to the crankshaft 7, the combustion restarts when the engine overall reaches the first TDC, and the engine is restarted.

On the other hand, although the possibility is low, when it is confirmed that the piston stop position of the compression-stroke-in-stop cylinder 2C is outside the reference stop position range (Step S22: NO), the restart controller 52 restarts the engine by injecting the fuel into the intake-stroke-in-stop cylinder 2D first (i.e., the second compression start) (Step S24). In other words, by injecting, while driving the starter motor 34 to apply the rotational force to the crankshaft 7, the fuel into the compression-stroke-in-stop cylinder for self-ignition when the engine overall passes the first TDC and the intake-stroke-in-stop cylinder 2D reaches the compression stroke, the combustion restarts when the engine overall reaches the second TDC, and the engine is restarted.

### (5) Operation and Effect

As described above, the start control device of the diesel engine (i.e., the compression self-ignition engine) according to this embodiment includes the ECU 50 for automatically stopping the engine when the predetermined automatic stop conditions are satisfied, and then, if the stop position of the piston 5 of the compression-stroke-in-stop cylinder 2C is within the reference stop position range, which is set relatively on the BDC side, when the predetermined restart condition is satisfied, by injecting the fuel into the compression-stroke-in-stop cylinder while applying the rotational force to the engine by using the starter motor 34, the ECU 50 restarts the engine. When automatically stopping the engine, the ECU 50 controls the opening of the intake throttle valve 30 so that the intake airflow amount (i.e., the second intake air amount) for the compression-stroke-in-stop cylinder 2C that is on the intake stroke between the final TDC of the cylinder 2C and the immediate previous TDC (2TDC) of the final TDC increases above the intake airflow amount (i.e., the first intake air amount) for the expansion-stroke-in-stop cylinder 2A that is on the intake stroke between the second previous TDC (3TDC) (iii) of the final TDC, and the 2TDC.

Immediately before the engine is automatically stopped, the intake air amount for the compression-stroke-in-stop cylinder 2C increases above the intake air amount for the expansion-stroke-in-stop cylinder 2A. Therefore, when the engine is stopped, the compressive reaction force inside the compression-stroke-in-stop cylinder 2C becomes relatively large, and the expansion reaction force inside the expansion-stroke-in-stop cylinder 2A becomes relatively small. Thus, the piston 5 of the compression-stroke-in-stop cylinder 2C naturally stops relatively on the BDC side and the piston 5 of the expansion-stroke-in-stop cylinder 2A naturally stops relatively on the TDC side. As a result, the piston 5 of the compression-stroke-in-stop cylinder 2C can be stopped relatively on the BDC side with high accuracy, and the engine can promptly be restarted by the first compression start.

In this embodiment, in the automatic stop control, the ECU 50 sets the opening of the intake throttle valve 30 to the opening corresponding to the first intake airflow amount (i.e., 0%) until the 2TDC (i.e., time point t4), and after the 2TDC (i.e., time point t4), the ECU 50 sets the opening of the intake throttle valve 30 to the opening (i.e., 30%) corresponding to the second intake airflow amount which is above the first intake flow amount.

By controlling the opening of the intake throttle valve 30, the intake air amount for the compression-stroke-in-stop cylinder 2C can stably and surely be increased above the intake air amount for the expansion-stroke-in-stop cylinder 2A, and the piston 5 of the compression-stroke-in-stop cylinder 2C can be stopped relatively on the BDC side with high accuracy. Further, because the intake throttle valve 30 is a conventional member provided to engines, the configuration of the start control device is not complex. Further, in the major part of the period of the automatic stop control until the 2TDC (i.e., time point t4), the opening of the intake throttle valve 30 is 0% and the intake airflow amount is relatively small; therefore, the compressive reaction force becomes relatively small and leads to good NVH during the automatic stop control. Additionally, in the major part of the period of the automatic stop control until the 2TDC (i.e., time point t4), the opening of the intake throttle valve 30 is 0% and the introduction of fresh air is relatively less; therefore, the cylinder is suppressed from being cooled internally and a fuel self-ignitability during the restart is secured.

### (6) Other Embodiments

In the above embodiment, the intake throttle valve 30 is used as the intake airflow amount adjuster; however, the variable valve mechanism 13a of the intake valve 11 may be used alternatively. In this case, during the automatic stop control, until the 2TDC (i.e., time point t4), the ECU 50 sets at least one of the lift and the opening and closing timings of the intake valve 11 to be at least one of the lift (i.e., a relatively small lift) and the opening and closing timings (i.e., the opening and closing timings in which an opening period of the intake valve 11 is relatively short) corresponding to the first intake airflow amount. After the 2TDC (i.e., time point t4), the ECU 50 sets at least one of the lift and the opening and closing timings of the intake valve 11 to be at least one of the lift (i.e., a relatively large lift) and the opening and closing timings (i.e., the opening and closing timings in which the opening period of the intake valve 11 is relatively long) corresponding to the second intake airflow amount which is above the first intake airflow amount.

By controlling at least one of the lift and the opening and closing timings of the intake valve 11 via the variable valve mechanism 13a, the intake air amount for the compression-stroke-in-stop cylinder 2C can stably and surely be increased above the intake air amount for the expansion-stroke-in-stop cylinder 2A, and the piston 5 of the compression-stroke-in-stop cylinder 2C can be stopped relatively on the BDC side with high accuracy. Further, because the variable valve mechanism 13a is a conventional member provided to engines, the configuration of the start control device is not complex. Further, in the major part of the period of the automatic stop control until the 2TDC (i.e., time point t4), the lift of the intake valve 11 is relatively small or the opening period of the intake valve 11 is relatively short, and the intake airflow amount is relatively small; therefore, the compressive reaction force becomes relatively small and leads to good NVH during the automatic stop control. Additionally, in the major part of the period of the automatic stop control until the 2TDC (i.e., time point t4), the lift of the intake valve 11 is relatively small or the opening period of the intake valve 11 is relatively short, and the introduction of fresh air is relatively less; therefore, the cylinder is suppressed from being cooled internally and a fuel self-ignitability during the restart is secured.

When the variable valve mechanism 13a of the intake valve 11 is used as the intake airflow amount adjuster, for example, in the automatic stop control, the ECU 50 (i.e., controller) closes the intake valve 11 early before the intake BDC until the 2TDC (i.e., time point t4), and after the 2TDC (i.e., time point t4), it closes the intake valve 11 late after the intake BDC. In this manner, by changing the closing timing of the intake valve 11 (i.e., IVC timing), the intake air amount for the compression-stroke-in-stop cylinder 2C can easily and surely be increased above the intake air amount for the expansion-stroke-in-stop cylinder 2A, and the piston 5 of the compression-stroke-in-stop cylinder 2C can be stopped relatively on the BDC side with high accuracy.

Note that, in the above embodiments, the timing of switching the opening of the intake throttle valve 30 and switching at least one of the lift and the opening and closing timings of the intake valve 11 is set to be the 2TDC (i.e., time point t4); however, not limited to this, as long as the intake air amount for the compression-stroke-in-stop cylinder 2C can be increased above the intake air amount for the expansion-stroke-in-stop cylinder 2A, the opening of the intake throttle valve 30 may be switched at a timing earlier or later than the 2TDC by a predetermined time period and at least one of the lift and the opening and closing timings of the intake valve 11 may be switched at a timing earlier or later than the 2TDC by a predetermined time period. In other words, the timing of switching the opening of the intake throttle valve 30 and switching at least one of the lift and the opening and closing timings of the intake valve 11 may be around the 2TDC.

Further, in the above embodiment, the opening of the intake throttle valve 30 is fully closed (i.e., 0%) at the time point t1 at which the engine automatic stop conditions are satisfied, and thereafter, at the time point t2 at which the intake pressure is decreased to some extent, the fuel cut for stopping the fuel injection from the fuel injection valve 15 is performed; however, the fuel cut may be performed at the time point t1 same as when the intake throttle valve 30 is fully closed.

Further, in the above embodiment, the example where the diesel engine (i.e., engine that combusts diesel fuel by self-ignition) is used, and the automatic stop and restart controls according to the above embodiment are applied to the diesel engine; however, the engine is not limited to the diesel engine as long as it is a compression self-ignition engine. For example, recently, a homogeneous-charge compression ignition (HCCI) engine where the fuel containing gasoline self-ignites by being compressed at a high compression ratio has been studied and developed. The automatic stop and restart controls according to the above embodiment can suitably be applied also to such a compression self-ignition gasoline engine.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

2A Expansion-Stroke-In-Stop Cylinder

2C Compression-Stroke-In-Stop Cylinder

2D Intake-Stroke-In-Stop Cylinder

5 Piston

13a Variable Valve Mechanism (Intake Airflow Amount Adjuster)

15 Fuel Injection Valve

30 Intake Throttle Valve (Intake Airflow Amount Adjuster)

34 Starter Motor

50 Electronic Control Unit (ECU)

1. A start control device, comprising:
a compression self-ignition engine;
fuel injection valves for injecting fuel into respective cylinders of the engine;
a piston stop position detector for detecting stop positions of pistons;
a starter motor for applying a rotational force to the engine, the engine combusting through a self-ignition, the fuel injected into the cylinders by the fuel injection valves;
a controller for automatically stopping the engine when a predetermined automatic stop condition is satisfied, and thereafter, when a predetermined restart condition is satisfied and the stop position of the piston of a compression-stroke-in-stop cylinder that is on a compression stroke while the engine is stopped is within a reference stop position range set relatively on a bottom dead center side, restarting the engine by injecting the fuel into the compression-stroke-in-stop cylinder while applying the rotational force to the engine by using the starter motor; and
an intake airflow amount adjuster for adjusting a flow amount of intake air into each cylinder,
wherein in automatically stopping the engine, the controller controls the intake airflow amount adjuster so that the intake airflow amount for one of the cylinders that is on an intake stroke between a final top dead center (TDC) of the cylinder immediately before the engine is stopped and an immediate previous TDC of the final TDC increases above an intake airflow amount for another cylinder on the intake stroke between a second previous TDC of the final TDC and the immediate previous TDC of the final TDC.

2. The device of claim 1, wherein the intake airflow amount adjuster is an intake throttle valve provided in an intake passage, and
wherein until around the immediate previous TDC of the final TDC, the controller sets an opening of the intake throttle valve to have a first intake airflow amount, and after around the immediate previous TDC of the final TDC, the controller sets the opening of the intake throttle valve to have a second intake airflow amount greater than the first intake airflow amount.

3. The device of claim 1, wherein the intake airflow amount adjuster is a variable valve mechanism for changing at least one of a lift and opening and closing timings of an intake valve, and
wherein until around the immediate previous TDC of the final TDC, the controller sets at least one of the lift and the opening and closing timings of the intake valve to have a first intake airflow amount, and after around the immediate previous TDC of the final TDC, the controller sets at least one of the lift and the opening and closing timings to have a second intake airflow amount above the first intake airflow amount.

4. The device of claim 3, wherein until around the immediate previous TDC of the final TDC, the controller closes the intake valve before a bottom dead center, and after around the immediate previous TDC of the final TDC, the controller closes the intake valve after the bottom dead center.

5. A method of controlling a start of a compression self-ignition engine, comprising:
injecting fuel into cylinders of the engine by fuel injection valves, respectively;
detecting stop positions of pistons;
applying a rotational force to the engine by a starter motor;
combusting the engine through a self-ignition, the fuel injected into the cylinders by the fuel injection valves;
automatically stopping the engine when a predetermined automatic stop condition is satisfied, and thereafter, when a predetermined restart condition is satisfied and the stop position of the piston of a compression-stroke-in-stop cylinder that is on compression stroke while the engine is stopped is within a reference stop position range set relatively on a bottom dead center side, restarting the engine by injecting the fuel into the compression-stroke-in-stop cylinder while applying the rotational force to the engine by using the starter motor; and
adjusting an intake airflow amount into each cylinder by an intake airflow amount adjuster,
wherein in automatically stopping the engine, the intake airflow amount adjuster is controlled so that the intake airflow amount for one of the cylinders that is on an intake stroke between a final top dead center (TDC) of the cylinder immediately before the engine is stopped and an immediate previous TDC of the final TDC increases above an intake airflow amount for another cylinder on the intake stroke between a second previous TDC of the final TDC and the immediate previous TDC of the final TDC.
